(19) United States
(12) Patent Application Publication
(10) Pub. No.: US 2023/0104172 A1
(43) Pub. Date: Apr. 6, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Tomoe Kikuchi, Tokyo (JP)

(21) Appl. No.: 17/937,960

(22) Filed: Oct. 4, 2022

(30) Foreign Application Priority Data
Oct. 5, 2021 (JP) 2021-164320

(51) Int. Cl. G06F 16/538; G06F 3/04847; G06F 3/04845; G06F 16/535

(52) U.S. Cl. CPC G06F 16/538; G06F 3/04847; G06F 3/04845; G06F 16/535; G06Q 30/0641

(57) ABSTRACT

An apparatus includes a setting unit configured to set an element to be given priority in search of data representing material appearance of an object, a search unit configured to search for the data based on the set element, and a control unit configured to display, on a display unit, an image that corresponds to the searched data and corresponds to appearance of the object in a case where the object is observed under a plurality of conditions.

### BACKGROUND

### Technical Field

The aspect of the embodiments relates to a technique to display data of material appearance of an object.

### Description of the Related Art

In recent years, various techniques for searching data including material appearance information have been proposed. For example, Japanese Patent Application Laid-Open No. 2017-37455 discusses a technique for searching for material information corresponding to verbal information input by a user, and displaying an image of a product made of the material indicated by the material information.

In a case where an object having appearance changed depending on an observation angle is searched for, it is not clear that the object has the material appearance intended by the user, by simply displaying one still image as the search result as in Japanese Patent Application Laid-Open No. 2017-37455, in some cases.

### SUMMARY

According to an aspect of the embodiments, an apparatus includes a setting unit configured to set an element to be given priority in search of data representing material appearance of an object, a search unit configured to search for the data based on the set element, and a control unit configured to display, on a display unit, an image that corresponds to the searched data and corresponds to appearance of the object in a case where the object is observed under a plurality of conditions.

Further features of the disclosure will become apparent from the following description of exemplary embodiments with reference to the attached drawings.

### BRIEF DESCRIPTION OF THE DRAWINGS

FIG. 1 is a block diagram illustrating a hardware configuration of an information processing apparatus.

FIGS. 2A to 2H are diagrams illustrating a search procedure.

FIG. 3 is a flowchart illustrating processing that is performed by the information processing apparatus.

FIG. 4 is a flowchart illustrating processing including display change and priority element update.

FIG. 5 is a flowchart illustrating search processing.

FIGS. 6A and 6B are diagrams each illustrating a feature vector.

FIG. 7 is a diagram illustrating a display example of search results.

FIG. 8 is a flowchart illustrating search processing.

FIGS. 9A and 9B are diagrams each illustrating a direction determination item.

FIG. 10 is a block diagram illustrating a functional configuration of the information processing apparatus.

### DESCRIPTION OF THE EMBODIMENTS

Some exemplary embodiments are described below with reference to the accompanying drawings. The following exemplary embodiments are not intended to limit the disclosure. All of combinations of characteristics described in the exemplary embodiments are not necessarily essential for solving means of the disclosure.

A first exemplary embodiment of the disclosure will be described below. Material appearance data representing a texture of an object is used for a user to recognize, via a display apparatus, change in color appearance and glossiness depending on a condition such as a position and brightness of illumination. In the present exemplary embodiment, a search corresponding to an input by the user is performed by using a database storing the material appearance data, and search results are displayed in a form of moving images on the display apparatus. Targets to be searched for in the present exemplary embodiment are images of curtains, but may be images of other objects.

### <Hardware Configuration of Information Processing Apparatus>

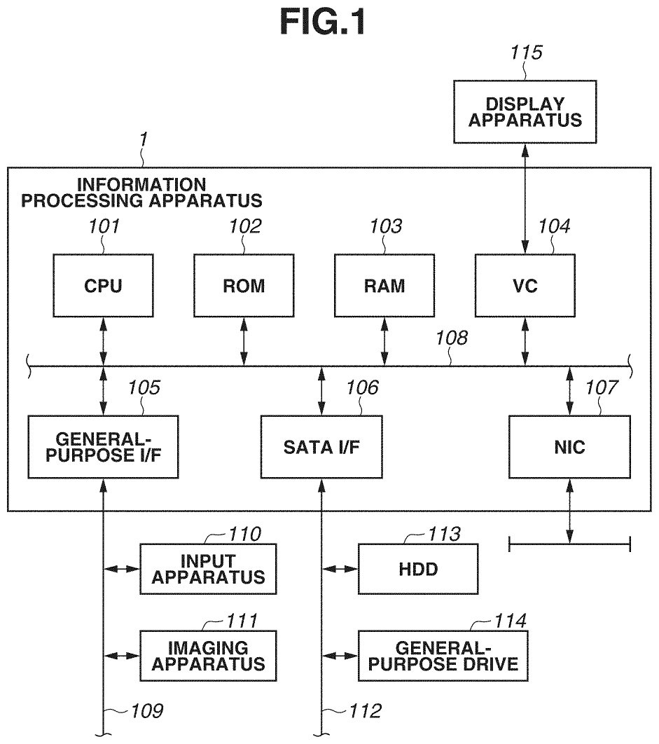

FIG. 1 is a block diagram illustrating a hardware configuration of an information processing apparatus 1. The information processing apparatus 1 includes a central processing unit (CPU) 101, a read only memory (ROM) 102, and a random access memory (RAM) 103. The information processing apparatus 1 further includes a video card (VC) 104, a general-purpose interface (I/F) 105, a serial advanced technology attachment (SATA) I/F 106, and a network interface card (NIC) 107. The CPU 101 executes an operating system (OS) and various programs stored in the ROM 102, a hard disk drive (HDD) 103, and the like by using the RAM 103 as a work memory. Further, the CPU 101 controls the components via a system bus 108. Processing based on flowcharts described below is realized by the CPU 101 loading program codes stored in the ROM 102, the HDD 113, and the like to the RAM 103 and executing the program codes. A display apparatus 115 is connected to the VC 104. An input apparatus 110, such as a mouse and a keyboard, and an imaging apparatus 111 are connected to the general-purpose I/F 105 via a serial bus 109. The HDD 113 and a general-purpose drive 114 that performs reading and writing of various types of recording media are connected to the SATA I/F 106 via a serial bus 112. The NIC 107 performs input and output of information with an external apparatus. The CPU 101 uses the HDD 113 and the various types of recording media mounted on the general-purpose drive 114 as a storage for various types of data. The CPU 101 displays a user interface (UI) provided by programs on the display apparatus 115, and receives an input such as a user instruction received via the input apparatus 110. The display apparatus 115 may be a touch panel display that includes a function of a touch panel that detects the position of a touch made by an indicator such as a finger.

### <Image Search Procedure>

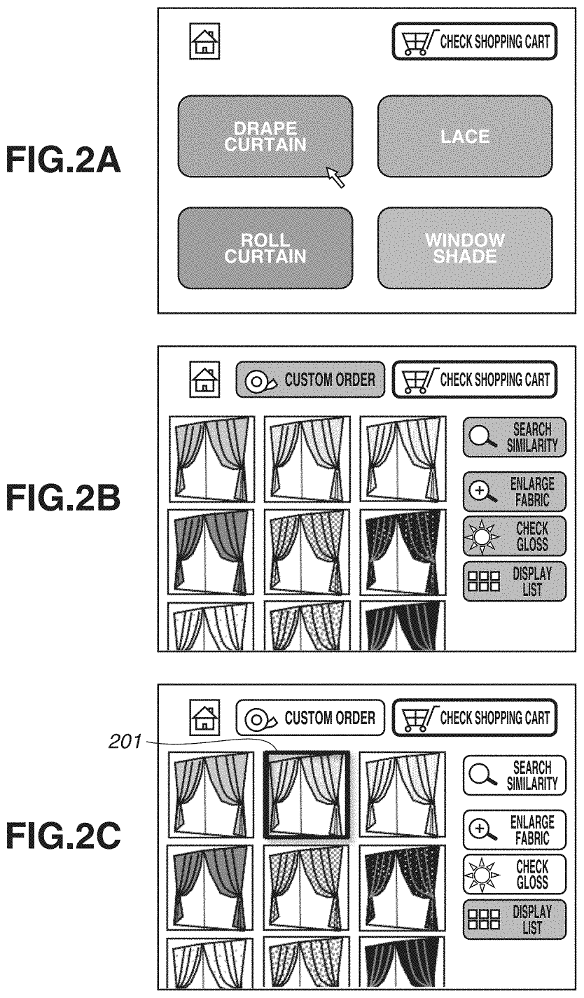

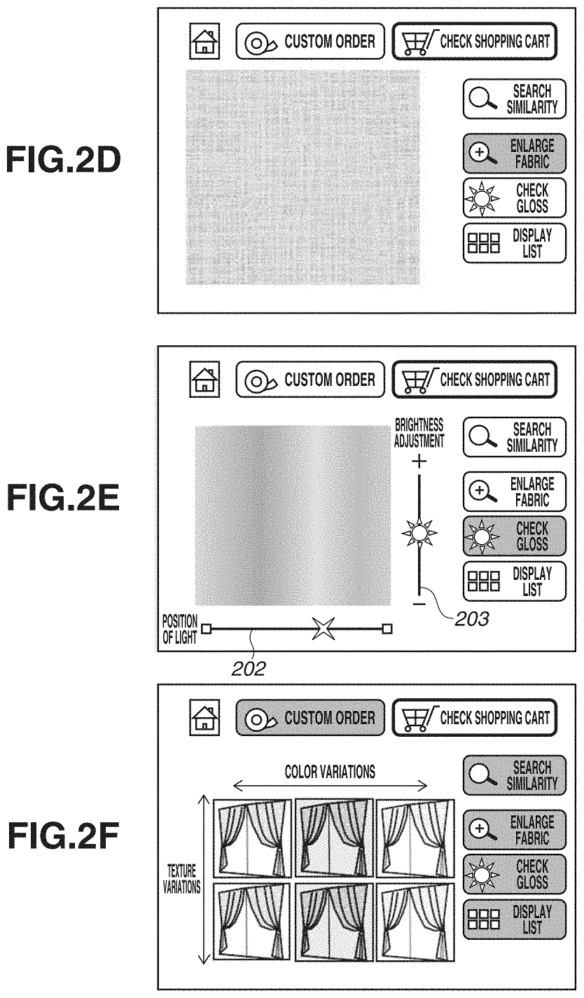

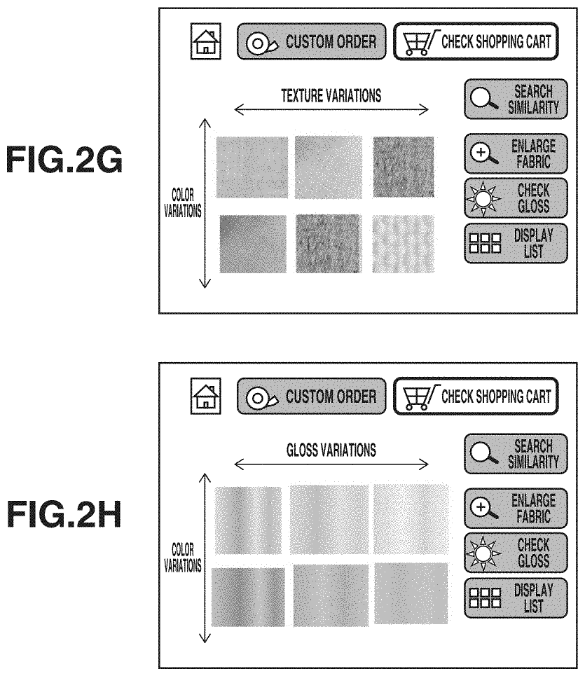

A procedure for searching for images of curtains according to the present exemplary embodiment will now be described with reference to FIGS. 2A to 2H. The user designates a type of a curtain on a display screen illustrated in FIG. 2A. In the present exemplary embodiment, a “drape curtain”, a “lace”, a “roll curtain”, and a “window shade” are presented as types of curtains. For example, when the “drape curtain” is selected in FIG. 2A, the display screen transitions to a screen in FIG. 2B, in which a list of thumbnail images corresponding to the “drape curtain” is displayed. Further, buttons, namely, “search similarity”, “enlarge fabric”, “check gloss”, and “display list”, are displayed with the list of the thumbnail images, so that the user can input a next instruction by using any of the displayed buttons. In FIG. 2B, the displayed buttons are grayed out and are unselectable. When the user selects an image of a favorite curtain in FIG. 2B, the selected image is surrounded by a frame 201, so that a selected state is indicated, as illustrated in FIG. 2C. When a single image is selected as illustrated in FIG. 2C, gray-out of the buttons for “search similarity”, “enlarge fabric”, and “check gloss”, other than the “display list” corresponding to the current display state is canceled, and the user is enabled to select these buttons. When the user double-clicks the selected image surrounded by the frame 201 in FIG. 2C, the whole of the selected curtain is enlarged and displayed as in an online shopping site.

When the “enlarge fabric” button is selected in FIG. 2C, the display screen transitions to a display screen in FIG. 2D. In the display screen in FIG. 2D, a fabric of the curtain surrounded by the frame 201 is enlarged, and an image is displayed such that irregularity on a surface is easily recognized. When the “check gloss” button is selected in FIG. 2C, the display screen transitions to a display screen in FIG. 2E. In the display screen in FIG. 2E, an image is displayed so as to enable gloss of the fabric of the curtain surrounded by the frame 201 to be checked. In the present exemplary embodiment, the user can adjust the position of a light source by a slider 202, and can adjust brightness of the light source by a slider 203. The user can check gloss (reflection of light) of the selected curtain by changing the position and the brightness of the light source. When the “display list” button is selected in a state where the display screen in FIG. 2D or FIG. 2E, each of which is the enlarged screen displaying the entire image of the curtain, namely, in a state where only one curtain is displayed on the entire screen, the display screen is returned to the display screen in FIG. 2C. When the “search similarity” button is selected in the display screen in FIG. 2C, FIG. 2D, or FIG. 2E, each of which is the enlarged screen displaying the entire image of the curtain, curtains similar in material appearance can be searched for. In a case where the similarity search is performed in the display screen in FIG. 2C, curtains similar to the curtain surrounded by the frame 201 are searched for. In a case where the similarity search is performed in the display screen in FIG. 2D, curtains each having a surface shape similar to the displayed surface shape are searched for. In a case where the similarity search is performed in the display screen in FIG. 2E, curtains each having gloss similar to the displayed gloss are searched for.

Search results are displayed in two axes as illustrated in FIG. 2F, FIG. 2G, and FIG. 2H. A combination of a horizontal axis and a vertical axis in FIG. 2F is a combination of color variations and texture variations. A combination of a horizontal axis and a vertical axis in FIG. 2G is a combination of texture variations and color variations. A combination of a horizontal axis and a vertical axis in FIG. 2H is a combination of gloss variations and color variations. The combination of the horizontal axis and the vertical axis may be a combination of color variations and gloss variations, and is not limited to the above-described examples. The horizontal axis and the vertical axis are changed depending on a user operation history before the similarity search is performed.

In the present exemplary embodiment, material appearance data corresponding to a plurality of curtains and thumbnail moving images with which the user can easily tell the material appearance of the respective curtains are stored in the HDD 113 in FIG. 1. The material appearance data includes three elements, namely, texture data representing a color element, normal map data representing a surface shape element, and specular map data representing a gloss element. The texture data is image data representing an image in which pixel values are represented by RGB values (R, G, and B). The normal map data is vector data of one channel indicating a normal direction at each point on the fabric surface of the curtain, and is used to reproduce a fine irregular shape. The specular map data includes information about specular reflection light on the surface of the curtain, and indicates a reflection direction and reflection intensity of light at each point on the surface. The specular map data is used to reproduce the gloss with the normal direction serving as a reference. The information about the specular reflection light includes information defining the normal, irregularity information finer than the normal information, and information about intensity, a width, and a direction of a specular reflection component determined by a physical property value.

### <Functional Configuration of Information Processing Apparatus>

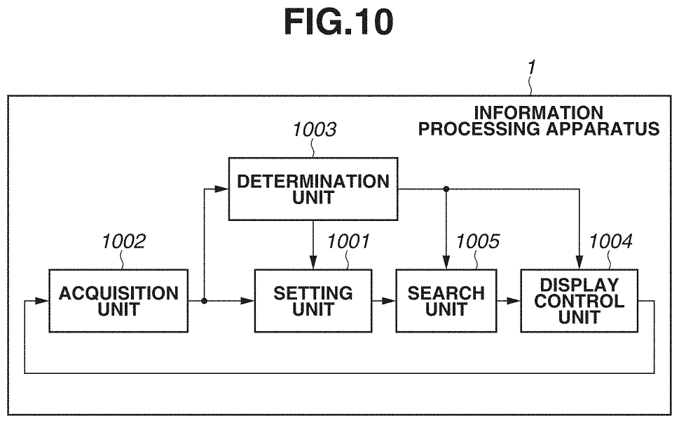

FIG. 10 is a block diagram illustrating a functional configuration of the information processing apparatus 1. The CPU 101 functions as the functional configuration illustrated in FIG. 10by using the RAM 103 as the work memory and reading out and executing the programs stored in the ROM 102 or the HDD 113. All of processing described below are not necessarily performed by the CPU 101, and the information processing apparatus 1 may be configured such that a part or all of the processing is performed by one or a plurality of processing circuits other than the CPU 101.

The information processing apparatus 1 includes a setting unit 1001, an acquisition unit 1002, a determination unit 1003, a display control unit 1004, and a search unit 1005. The setting unit 1001 sets elements to be given priority in search of the material appearance data. The acquisition unit 1002 acquires instruction information indicating a user instruction. The determination unit 1003 determines whether the instruction from the user indicates similarity search, based on the acquired instruction information. The display control unit 1004 controls display of the display apparatus 115. The search unit 1005 searches for the material appearance data.

### <Processing Performed by Information Processing Apparatus>

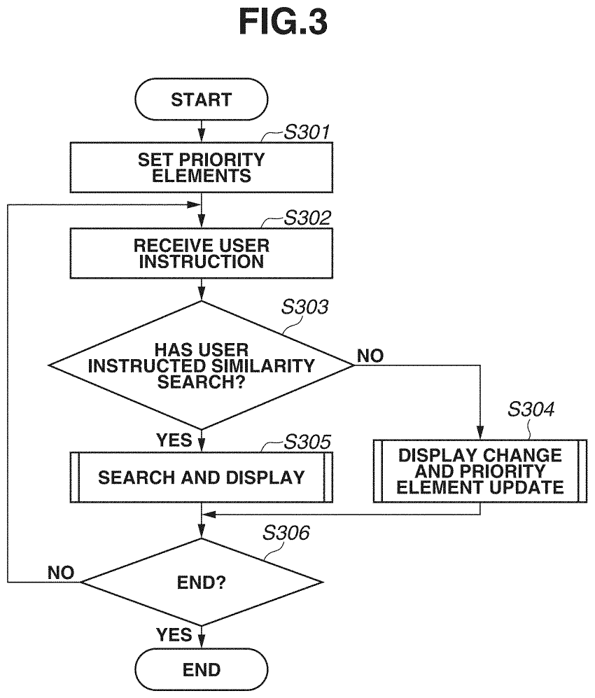

Processing that is performed by the information processing apparatus 1 according to the present exemplary embodiment will now be described with reference to a flowchart of FIG. 3. The processing of the flowchart in FIG. 3 starts when the user inputs the instruction via the input apparatus 110 and the CPU 101 receives the input instruction.

In step S301, the setting unit 1001 initializes two elements to be given priority in search of the material appearance data. The setting unit 1001 according to the present exemplary embodiment sets a color as a first priority element, and sets a surface shape as a second priority element. In step S302, the acquisition unit 1002 acquires the instruction information indicating the user instruction. The instruction is input by the user via the input apparatus 110. In step S303, the determination unit 1003 determines whether the instruction information acquired in step S302 indicates execution of the similarity search. In a case where the instruction information acquired in step S302 indicates execution of the similarity search (YES in step S303), the processing proceeds to step S305. Otherwise (NO in step S303), the processing proceeds to step S304. In step S305, the search unit 1005 searches for the material appearance data, and the display control unit 1004 displays search results on the display apparatus 115. The details of the search processing in step S305 will be described below. In step S304, the display control unit 1004 changes the display of the display apparatus 115 in accordance with the instruction indicated by the instruction information acquired in step S302. The setting unit 1001 updates contents of the priority elements. Details of the processing of changing the display and the processing of updating the priority elements in step S304 will be described below. In step S306, the determination unit 1003 determines whether to end the series of processing, based on whether an end instruction has been received from the user. If the series of processing is not to be ended (NO in step S306), the processing returns to step S302, and the acquisition unit 1002 newly acquires the instruction information.

### <Processing of Changing Display and Updating Priority Elements (S304)>

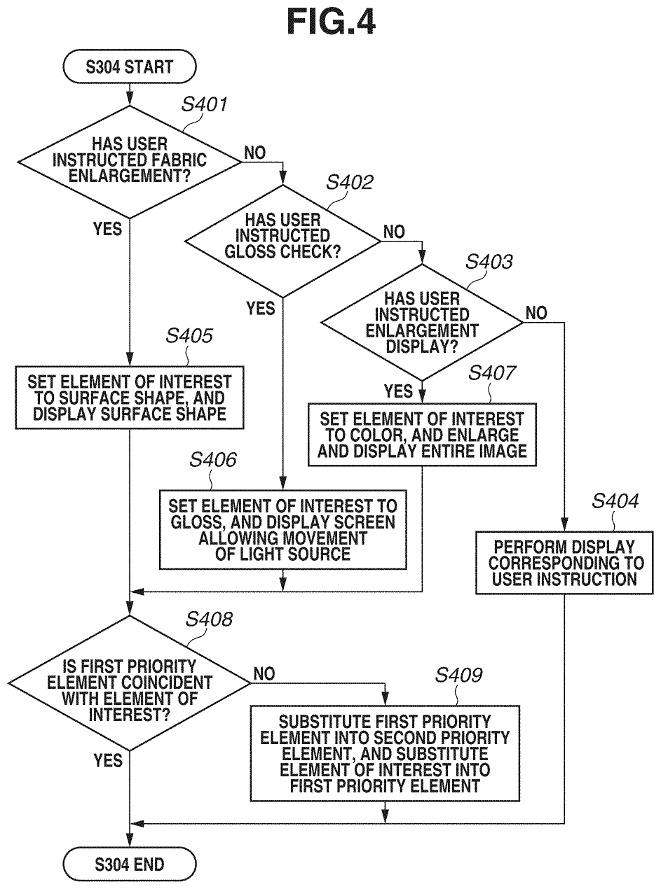

The processing to change the display and to update the priority elements in step S304 will be described with reference to a flowchart of FIG. 4. In step S401, the setting unit 1001 determines whether the instruction information acquired in step S302 indicates “fabric enlargement”. In a case where the instruction information acquired in step S302 indicates “fabric enlargement” (YES in step S401), the processing proceeds to step S405. In step S405, the setting unit 1001 sets an element of interest to the surface shape, and the display control unit 1004 displays the surface shape of the fabric on the display apparatus 115. In a case where the instruction information acquired in step S302 does not indicate “fabric enlargement” (NO in step S401), the processing proceeds to step S402. In step S402, the setting unit 1001 determines whether the instruction information acquired in step S302 indicates “gloss check”.

In a case where the instruction information acquired in step S302 indicates “gloss check” (YES in step S402), the processing proceeds to step S406. In step S406, the setting unit 1001 sets the element of interest to the gloss, and the display control unit 1004 displays a screen on which the user can adjust the movement of the light source, on the display apparatus 115. In a case where the instruction information acquired in step S302 does not indicate “gloss check” (NO in step S402), the processing proceeds to step S403. In step S403, the setting unit 1001 determines whether the instruction information acquired in step S302 indicates an instruction to enlarge and display the entire image of the selected curtain. In a case where the instruction information acquired in step S302 indicates the instruction to enlarge and display the entire image of the selected curtain (YES in step S403), the processing proceeds to step S407. In step S407, the setting unit 1001 sets the element of interest to the color, and the display control unit 1004 enlarges and displays the entire image of the curtain. In a case where the instruction information acquired in step S302 does not indicate the instruction to enlarge and display the entire image of the selected curtain (NO in step S403), the processing proceeds to step S404.

In step S404, the display control unit 1004 changes the display to the display corresponding to the instruction indicated by the instruction information. For example, in a case where the “display list” button is selected, the screen is returned to the screen displaying the list, in the processing in step S404. In a case where any of the other buttons is selected, the screen transitions to the screen corresponding to the selected button. In a case where the setting unit 1001 updates the element of interest and the display control unit 1004 updates the display screen in step S405, S406, or S407, the processing proceeds to step S408. In step S408, the setting unit 1001 determines whether the first priority element is coincident with the element of interest updated in step S405, S406, or S407. If the first priority element is coincident with the element of interest (YES in step S408), the processing in step S304 is ended. If the first priority element is not coincident with the element of interest (NO in step S408), the processing proceeds to step S409. In step S409, the setting unit 1001 substitutes the first priority element into the second priority element, and substitutes the element of interest set in step S405, S406, or S407 into the first priority element. The first priority element and the second priority element are parameters used in the search processing in step S305.

In a case where the user instruction received last and the user instruction received before the last user instruction are the same in the above-described processing, the first priority element and the second priority element are not updated. In a case where the user instruction received last is the instruction about update of the priority elements and is different from the user instruction about update of the priority elements received before the last user instruction, the first priority element and the second priority element are both updated. During the update, the first priority element is set down to the second priority element, and the first priority element is determined based on the last user instruction.

### <Search Processing (S305)>

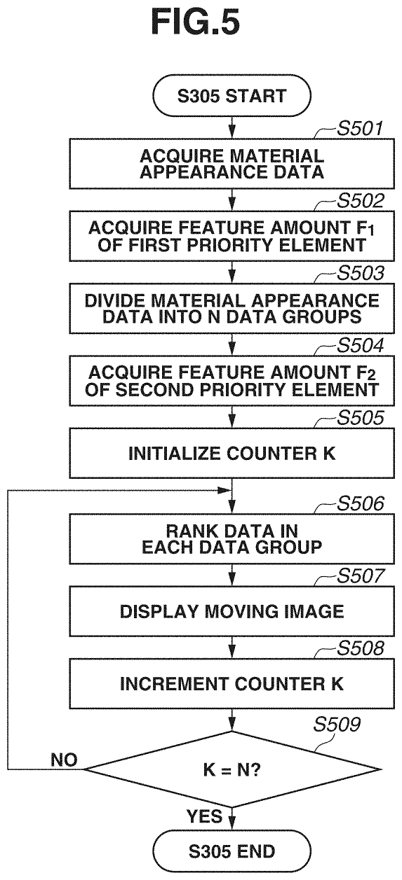

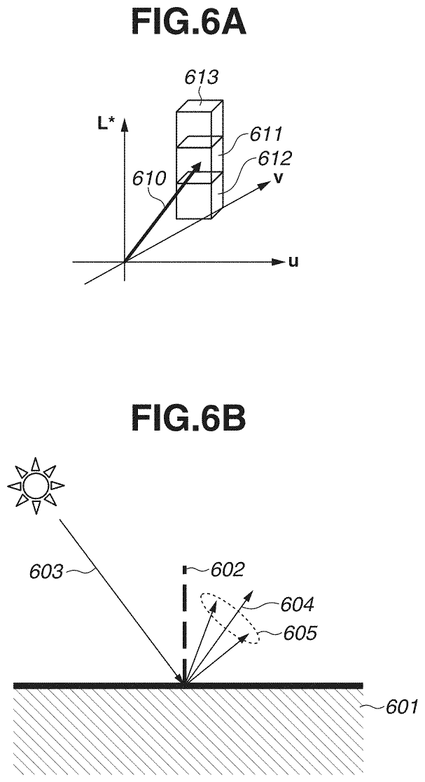

The search processing in step S305 is described with reference to a flowchart of FIG. 5. In step S501, the search unit 1005 acquires material appearance data corresponding to the selected image, namely, the image surrounded by the frame 201 in FIG. 2C. In step S502, the search unit 1005 acquires a feature amount F₁ of the first priority element. The first priority element according to the present exemplary embodiment is any of the color, the surface shape, and the gloss. In the present exemplary embodiment, as a feature amount of the color, a representative Luv vector that becomes maximum in a histogram in a Luv space, in the texture data corresponding to a predetermined area is used. More specifically, as illustrated in FIG. 6A, the Luv space is divided into unit cubes, the pixel values of the predetermined image area included in each of the cubes are counted, and a vector to the center coordinate of the cube including the largest number of pixels is used as the feature amount of the color. As a feature amount of the surface shape, a Gabor filter is applied to the normal map data corresponding to the predetermined area, and a mean vector and a distribution vector are used. As a feature amount of the gloss, a histogram is created based on intensity and spread of the gloss in the specular map data corresponding to the predetermined area in a manner similar to the feature amount of the color, and a combination of intensity and spread that becomes maximum in the histogram is used as the feature amount. More specifically, as illustrated in FIG. 6B, the histogram is created based on a vector 604 of a component strongest in specular reflection and a spreading width 605 of the specular reflection component in a case where light 603 is applied from a prescribed position to a surface 601 having a normal 602 in each pixel. These feature amounts are previously derived, and are stored as information about the material appearance data.

In step S503, the search unit 1005 divides all material appearance data into predetermined N data groups Ga(0) to Ga(N−1) in the order of proximity to the selected image by using the feature amount F₁. In the present exemplary embodiment, N is set to four. The proximity of the data is defined by a distance (difference) of the feature amount F₁, and the data groups can be generated by dividing the distance by four stages. In step S504, the search unit 1005 acquires a feature amount F₂ of the second priority element. In step S505, the search unit 1005 initializes a counter K by substituting zero into the counter K. In step S506, the search unit 1005 ranks the proximity of the data in the data group Ga(K) to the material appearance data acquired in step S501, by using the feature amount F₂. The proximity of the feature amount is defined by a distance of the feature amount F₂. In step S507, the search unit 1005 acquires thumbnail moving images corresponding to the respective pieces of data included in the data group Ga(k) in accordance with the ranking set in step S506. The display control unit 1004 displays the acquired thumbnail moving images on the display apparatus 115. The thumbnail moving images are previously generated as moving images that facilitate check of appearance change in observation with different geometric conditions, for example, by allowing change in the light source position, inclining the object, or changing a viewpoint of the user in each piece of the data. The generated thumbnail moving images are stored as the material appearance data. In step S508, the search unit 1005 increments the counter K by one. In step S509, the search unit 1005 compares the counter K and the number of divisions in step S503. In a case where the counter K and the number of divisions are equal to each other (YES in step S509), it is determined that the calculation of the distance and the ranking based on the feature amount F₂ are performed on all of the data groups, and the processing is ended. In a case where the counter K and the number of divisions are not equal to each other (NO in step S509), the processing returns to step S506 in order to perform the calculation of the distance based on the feature amount F₂ and the display of the next data group.

In the present exemplary embodiment, as the search results, the data groups Ga(0), Ga(1), and Ga(2) are displayed in order from left to right. The pieces of data in each of the groups are displayed in ascending order of proximity in distance of the feature amount F₂ from top to bottom. FIG. 2F illustrates the search results in a case where the first priority element is the color and the second priority element is the surface shape. The upper-left data is the one selected by the user, and the piece of data in the data group Ga(0) closest in color to the selected data are arranged below the selected data in a descending order of similarity in surface shape to the selected data. The pieces of data in the center column are a data group that is the second closest in color to the selected data, and the data group is further arranged in a horizontal direction in descending order of similarity in surface shape. FIG. 2G illustrates search results in a case where the first priority element is the surface shape, and the second priority element is the color. FIG. 2H illustrates search results in a case where the first priority element is the gloss, and the second priority element is the color.

According to the present exemplary embodiment, the user can check the search results of data similar to the selected data, with the moving images with which the user can easily tell the material appearance, thus enabling the user to easily narrow down the search results. In the present exemplary embodiment, the display enabling the user to easily recognize the elements used for the determination of similarity is performed. Further, the elements used for the determination are determined by the user instruction. Therefore, elements strongly interested by the user or important elements are automatically reflected on the search results.

### <Modification>

In the present exemplary embodiment, the case where the texture data, the normal map data, and the specular map data are stored as the data corresponding to the three elements (color, surface shape, and gloss) configuring the material appearance data is described. However, the material appearance data is not limited to the above-described example. For example, the data corresponding to the three elements may be the texture data, an onomatopoeia about hand feeling, and an onomatopoeia about the gloss. The onomatopoeia about the hand feeling is configured by a combination of a word representing the surface shape such as “smooth”, “superfine”, “dry”, “fluffy”, “coarse”, and “rough”, and presence/absence of a word representing a degree such as “very”, “somewhat”, and “slightly” in this modification. The onomatopoeia about the gloss is configured by a combination of a word representing the light reflection degree, presence/absence of a word representing a degree, and presence/absence of a word representing a coverage. Examples of the word representing the light reflection degree include “mat”, “glossy”, and “shiny”. Examples of the word representing the degree include “very”, “somewhat”, and “slightly”. Examples of the word representing the coverage include “totally”, “partially”, “in places”, and “in spots”. Values obtained by one-dimensionally quantifying these onomatopoeias are used as the feature amount of the surface shape and the feature amount of the gloss.

A method of quantifying the onomatopoeia about the surface shape will be described. Numerical values 10, 20, . . . , and 60 are assigned to the words representing the surface shape, “smooth”, “superfine”, “dry”, “fluffy”, “coarse”, and “rough”. Further, numerical values −7, −5, and −3 are respectively assigned to the words representing the degree, “very”, “somewhat”, and “slightly”. In a case where the word representing the surface shape itself is combined with the word representing the degree as the surface shape element of certain data, a value obtained by summing the both numerical values is used as the feature amount corresponding to the onomatopoeia about the surface shape. As a result, the distance of the feature amount can be derived.

A method of quantifying the onomatopoeia about the gloss will be described. The material appearance data inevitably includes the onomatopoeia of the gloss combined with the word “totally” representing the coverage, and may further include the onomatopoeia combined with the word representing the other coverage. In other words, there are data including only the onomatopoeia about the gloss, “totally”+“very”+“mat”, and data including two onomatopoeias, “totally”+“very”+“mat” and “shiny”+“in places”. Numerical values 10, 30, and 50 are respectively assigned to the words representing the light reflection degree, “mat”, “glossy”, and “shiny”. Numerical values −5, 5, and 10 are respectively assigned to the words representing the degree, “very”, “somewhat”, and “slightly”. Numerical values 1.0, 0.5, 0.3, and 0.1 are respectively assigned to the words representing the coverage, “totally”, “partially”, “in places”, and “in spots”. The numerical value of each onomatopoeia is calculated by (numerical value of light reflection degree)+(numerical value of degree)×(numerical value of coverage). The distance of the feature amount can be derived by using the numerical value as the feature amount of the gloss.

A second exemplary embodiment of the disclosure will be described below. In the first exemplary embodiment, the search results are presented to the user by using proximity of the feature amount of each element, as illustrated in FIGS. 2F to 2H. In other words, for the texture data, in the case where a color represented by the vector 610 in FIG. 6A is included in an area 611, a feature amount vector having the distance equal to the vector 610 is set in each of an area 612 and an area 613, and data in the both areas are disposed based on the distance. In the present exemplary embodiment, directionality is reflected when similarity of the feature amount is derived, and the directionality is also presented to the user when the search results are displayed.

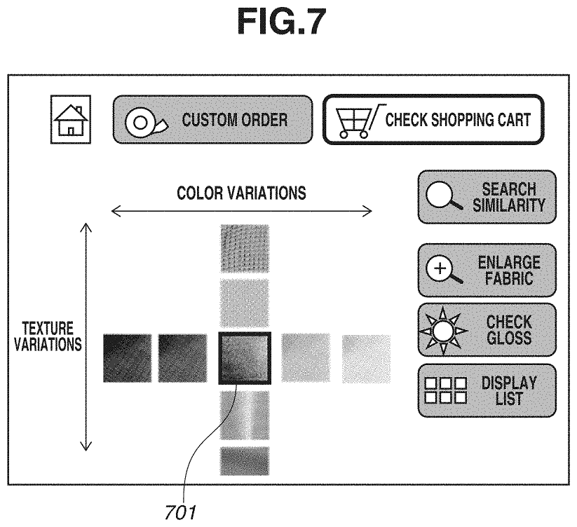

Presenting the search results as in the present exemplary embodiment makes it possible to set an axis to further display the search results among a plurality of pieces of data configuring each element data, and to arrange information about the search results based on the added axis with a reference. FIG. 7 illustrates a display example of search results according to the present exemplary embodiment. An image surrounded by a frame 701 is an image selected when similar images are searched for. The similar images are searched for based on the image surrounded by the frame 701 with the first priority element set to the color and the second priority element set to the surface shape, and results of the search are displayed.

The present exemplary embodiment is different in the search processing in step S305 from the first exemplary embodiment. A hardware configuration and a functional configuration of an information processing apparatus according to the present exemplary embodiment are equivalent to the hardware configuration and the functional configuration of the information processing apparatus according to the first exemplary embodiment. Thus, descriptions of the hardware configuration and the functional configuration are omitted. In the following, differences between the present exemplary embodiment and the first exemplary embodiment are mainly described. The components similar to those in the first exemplary embodiment are described while being denoted by the same reference numerals.

### <Search Processing (S305)>

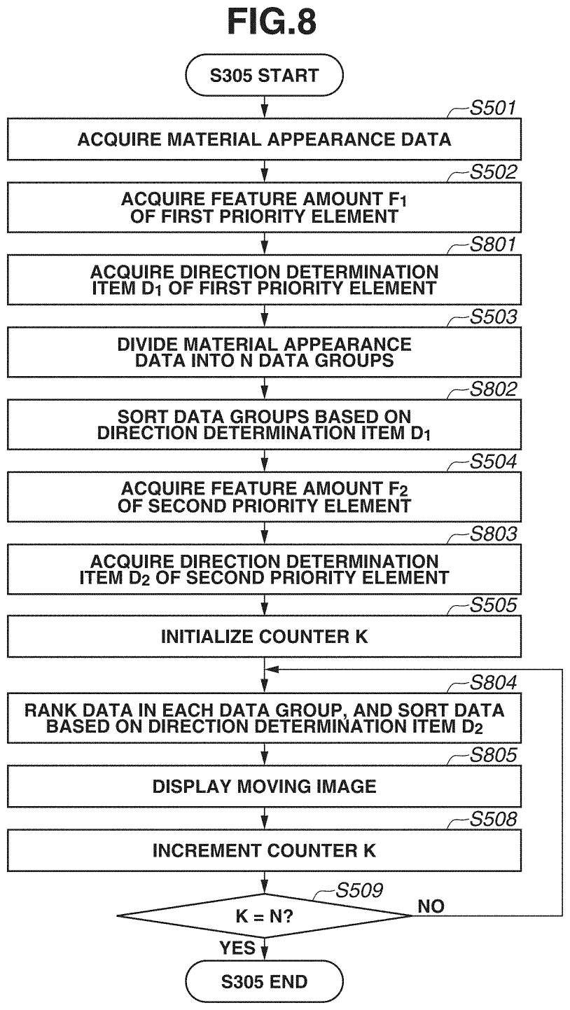

The search processing in step S305 will now be described with reference to a flowchart of FIG. 8. Operations in steps S501 to S505, S508, and S509 are similar to those in the first exemplary embodiment. Thus, descriptions thereof are omitted. In step S801, the search unit 1005 acquires a direction determination item D₁ of the first priority element acquired in step S502. The direction determination item D₁ according to the present exemplary embodiment is previously determined for each material appearance data, and a L* value is used for the element “color”, dispersion is used for the element “surface shape”, and a length of a vector of a component strongest in specular reflection is used for the element “gloss”. Although various axes may be defined other than above, the axis may be appropriately selected based on a display method.

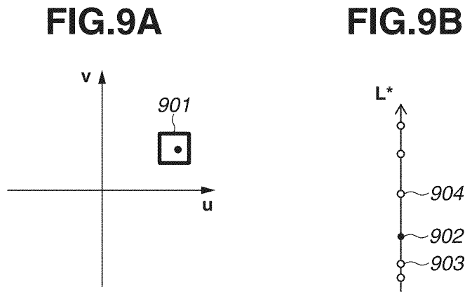

In step S802, the search unit 1005 sorts the data groups Ga(0) to Ga(N−1) by using the direction determination item D₁ acquired in step S801. A frame 901 in FIG. 9A indicates that an area of the data group Ga(K) (K is any of 0 to N−1) is projected to an a*b* plane in a L*a*b* space which is used for calculation of the feature amount F₁ of the color. FIG. 9B is a conceptual diagram in which data of L*a*b* values positioned at centers of the respective data groups Ga(0) to Ga(N−1) are one-dimensionally arranged based on the L* value. A point 902 corresponds to the L* value of the selected image. A point 903 and a point 904 are substantially equal in distance from the point 902, but are located in an opposite direction with reference to the point 902 in the L* axis. A reference to determine which side of the reference the target point is located away from the reference even though the distances of the target points from the reference are substantially equivalent to each other is the direction determination item D₁. Similarly, as for the surface shape, the axis in FIG. 9B indicates the dispersion, and as for the gloss, the axis in FIG. 9B indicates the length of the vector.

In step S803, the search unit 1005 acquires a direction determination item D₂ of the second priority element.

In step S 804, as in the first exemplary embodiment, the search unit 1005 ranks the pieces of data in the data group Ga(K) by using the feature amount F₂. The search unit 1005 further sorts the ranked pieces of data based on the direction determination item D₂. The pieces of data are sorted in a manner similar to the method in step S802.

However, in this step, not the value located at the center of the area but a value of respective pieces of data may be used. In step S805, the search unit 1005 acquires moving images for check of the material appearance in order of the pieces of data sorted in step S804, and the display control unit 1004 displays the acquired moving images on the display apparatus 115 as in FIG. 7.

### <Modification>

In the present exemplary embodiment, as in the modification of the first exemplary embodiment, the surface shape and the gloss may be held as the onomatopoeia. In the present exemplary embodiment, as the direction determination item, a word representing a degree may be used for the surface shape and the gloss, and a word representing a coverage may be used for the gloss.

### Other Exemplary Embodiments

In the above-described exemplary embodiments, the normal map data is used as the data representing the surface shape; however, bump map data or height map data may be used. The specular map data is used as the data representing the gloss; however, diffuse map data may be used.

In the above-described exemplary embodiments, the texture data, the normal map data, and the specular map data are used as the material appearance data; however, the material appearance data is not limited to the above-described example. For example, elements, such as transparency and diffuse, reflection may be added, and four or more types of material appearance data may be used. Two elements can be selected based on the user operation history, and similarity can be defined and displayed.

The processing according to the above-described exemplary embodiments may be realized by a stand-alone search apparatus or may be realized by a search system including a server and a client via a network. In a case where the information processing apparatus 1 is the stand-alone search apparatus, the user instruction is received via the input apparatus 110, and the display of the search results and the like are performed by using the display apparatus 115. In contrast, in a case where the search system including the server and the client is used, the information processing apparatus 1 serving as the server receives the user instruction through communication via the NIC 107. Further, the information processing apparatus 1 provides data to be used for display of the search results and the like, to the client apparatus through communication via the NIC 107.

The information processing apparatus 1 may be a mobile device including an acceleration sensor and an image sensor like a tablet personal computer (PC). In this case, the light source position may be changed based on sensing of inclination of a device main body, or a surrounding light source (e.g., fluorescent lamp, outdoor lamp, or tungsten) may be determined by using the image sensor, and the display image may be changed based on a result of the determination.

In the above-described modifications, the onomatopoeia of the surface shape and the onomatopoeia of the gloss are each described as the combination of the limited words, but are not limited to the above-described examples. The words may be changed to other words, for example, scratchy, rough, lumpy, crunchy, and brightly, or other words may be added. The words representing the degree and the words representing the coverage are used, but words representing impression (silky, mannish, quiet, tender) may be used.

In the above-described exemplary embodiments, the moving images, each having a thumbnail size, with which the user easily understand the material appearance information are used as the search results; however, any other method with which the user can check the material appearance may be used. For example, data enabling display of the material appearance may be rendered and displayed, or still images different in geometric condition may be continuously displayed. In these cases, it is unnecessary to previously store the thumbnail moving images, thus reducing a necessary data capacity.

In the above-described exemplary embodiments, the example in which, as the UI screen to check the gloss, the position and the brightness of the light source are changed has been described in FIG. 2E; however, intensity, a color temperature, and the like of the light source may be changeable.

According to the exemplary embodiments of the disclosure, in a case where the data representing the material appearance of an object is searched for, it is possible to easily check whether the search results intended by the user are obtained.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-164320, filed Oct. 5, 2021, which is hereby incorporated by reference herein in its entirety.

1. An apparatus, comprising:
a setting unit configured to set an element to be given priority in search of data representing material appearance of an object;
a search unit configured to search for the data based on the set element; and
a control unit configured to display, on a display unit, an image that corresponds to the searched data and corresponds to appearance of the object in a case where the object is observed under a plurality of conditions.

2. The apparatus according to claim 1, wherein the control unit displays a moving image as the image on the display unit.

3. The apparatus according to claim 1, wherein the control unit continuously displays, as the image, a still image corresponding to each of the plurality of conditions on the display unit.

4. The apparatus according to claim 1, further comprising a reception unit configured to receive a user instruction to designate data to be searched for,
wherein the search unit searches for, from among a plurality of pieces of data, data similar, in the element to be given priority, to the data to be searched for.

5. The apparatus according to claim 4,
wherein the setting unit sets a first element and a second element as the element to be given priority,
wherein the search unit searches for data by using the first element to acquire a first group, and searches for data by using the second element from the first group, and
wherein the control unit displays the image relating to the data which has found by using the second element, on the display unit.

6. The apparatus according to claim 5, wherein the control unit displays the image relating to the data which has found using the second element on the display unit based on similarity of the first element and similarity of the second element to the data to be searched for.

7. The apparatus according to claim 1, wherein the element to be given priority includes at least one of a color, gloss, and a surface shape.

8. The apparatus according to claim 1, wherein the plurality of conditions is different in at least one of a position of a light source, intensity of the light source, a color temperature of the light source, and a position of a viewpoint.

9. The apparatus according to claim 1, wherein, in a case where a user instruction indicating (1) list display of images is received, the setting unit sets a color as the element to be given priority, (2) enlargement display of an image, the setting unit sets a surface shape as the element to be given priority or (3) movement of a light source is received, the setting unit sets gloss as the element to be given priority.

10. A method, comprising:
setting an element to be given priority in search of data representing material appearance of an object;
searching for data based on the set element to be given priority; and
displaying, on a display unit, an image that corresponds to the data obtained in the search and corresponds to appearance of the object in a case where the object is observed under a plurality of conditions.

11. The method according to claim 10, further comprising receiving a user instruction to designate data to be searched for,
wherein the searching searches for, from among a plurality of pieces of data, data similar, in the element to be given priority, to the data to be searched for.

12. The method according to claim 10, wherein the element to be given priority includes at least one of a color, gloss, and a surface shape.

13. The method according to claim 10, wherein the plurality of conditions is different in at least one of a position of a light source, intensity of the light source, a color temperature of the light source, and a position of a viewpoint.

14. The method according to claim 10, wherein, in a case where a user instruction indicating (1) list display of images is received, the setting sets a color as the element to be given priority, (2) enlargement display of an image, the setting sets a surface shape as the element to be given priority or (3) movement of a light source is received, the setting sets gloss as the element to be given priority.

15. A non-transitory computer-readable storage medium storing instructions that, when executed by a computer, cause the computer to perform a method, the method comprising:
setting an element to be given priority in search of data representing material appearance of an object;
searching for the data based on the set element to be given priority; and
displaying, on a display unit, an image that corresponds to the data obtained in the search and corresponds to appearance of the object in a case where the object is observed under a plurality of conditions.

16. The non-transitory computer-readable storage medium according to claim 15, further comprising receiving a user instruction to designate data to be searched for,
wherein the searching searches for, from among a plurality of pieces of data, data similar, in the element to be given priority, to the data to be searched for.

17. The non-transitory computer-readable storage medium according to claim 15, wherein the element to be given priority includes at least one of a color, gloss, and a surface shape.

18. The non-transitory computer-readable storage medium according to claim 15, wherein the plurality of conditions is different in at least one of a position of a light source, intensity of the light source, a color temperature of the light source, and a position of a viewpoint.

19. The non-transitory computer-readable storage medium according to claim 15, wherein, in a case where a user instruction indicating (1) list display of images is received, the setting sets a color as the element to be given priority, (2) enlargement display of an image, the setting sets a surface shape as the element to be given priority or (3) movement of a light source is received, the setting sets gloss as the element to be given priority.
